(19) United States
(12) Patent Application Publication
(10) Pub. No.: US 2007/0294409 A1
(43) Pub. Date: Dec. 20, 2007

(54) Internet based network topology discovery

(76) Inventor: Arvind Kumar, Beaverton, OR (US)

Correspondence Address: INTEL/BLAKELY, 1279 OAKMEAD PARKWAY, SUNNYVALE, CA, 94085-4040, US

(21) Appl. No.: 11/893,868

(22) Filed: Aug. 17, 2007

Related U.S. Application Data
(63) Continuation-in-part of application No. 09/675,622, filed on Sep. 29, 2000, now Pat. No. 7,272,644.

(51) Int. Cl. G06F 15/173; G06F 17/30

(52) U.S. Cl. 709/226; 707/4

(57) ABSTRACT

A system and method are provided for internet-based network topology discovery. A server in communication with a client, the server having a console having a managing device is provided to manage one or more network devices. A search engine is provided that is in communication with the managing device via a network including the Internet, the search engine capable of being accessed via the client. The console is used to formulate an Extensible Markup Language (XML) discovery information query, wherein the XML discovery information query is initiated automatically by the client. The console is further to send the XML discovery information query to the search engine to facilitate searching of discovery information relevant to the one or more network devices, wherein at least one of the one or more network devices includes an XML discovery information file, wherein at least one of the one or more network devices does not include the XML discovery information file. In response to sending the XML discovery information query, the console to receive one or more of the following via the search engine: first discovery information from the one or more network devices having the XML discovery information file, and second discovery information from a proxy device for the one or more network devices not including the XML discovery information files. The console is further used to generate a network topology map for the one or more network devices via the retrieved first and second discovery information.

### RELATED APPLICATION

This is a continuation application of U.S. patent application Ser. No. 09/675,622, entitled Internet Based Network Topology Discovery, filed on Sep. 29, 2000, now allowed, and priority is claimed thereof.

### FIELD OF THE INVENTION

This invention relates generally to computer network or systems management and, more particularly, to discovery of network devices.

### BACKGROUND OF THE INVENTION

The task of computer network and systems management is challenged with the complexities of the systems networked in variety of ways. With large numbers of connected computers and other devices, it is difficult to manage a network. Many common network management tools use a process called “discovery of the network.” Discovery of a network of computers or other devices typically involves finding information about which devices are connected to the network. Among the categories of information discovered are, for example, IP addresses of the devices, types of devices, or capabilities of the devices. Among the networked devices that can be “discovered” are computers, printers, servers, switches, modems, etc.

The discovery data of a network is typically used for network management or administration. The data can be formatted into a table or a network “tree” which can then be displayed or manipulated for network management purposes.

Typical network management tools use various ways to discover the network. Most of these are not scalable and break down for the discovery of systems on the Internet. One example of a network discovery method is commonly referred to as a “ping sweep” method. In the ping sweep method, an operator or network administrator sends individual queries to the network from a console. The queries, or “pings,” are messages to the network that are directed to a particular device or group of devices that respond with a return message. One example of a ping sweep network search method requires the network administrator to search by IP addresses, incrementing the last digit (or set of digits) of the IP address, for example, until a particular device with the generated IP address is found. The ping sweep method of network discovery is a time consuming manual process. Network traffic is also increased when the ping sweep method is used. One way to shorten time required for a ping sweep search is to use a broadcast method. Broadcasting a ping sweep, however, also creates added network traffic.

### DESCRIPTION OF THE DRAWINGS

The present invention is illustrated by way of example, and not limitation, in the figures of the accompanying drawings in which:

FIG. 1 is a flowchart showing one embodiment of a method of the present invention;

FIG. 2 is a schematic of a network showing an embodiment of a system of the present invention;

FIG. 3 is a schematic of a network showing another embodiment of a system the present invention;

FIG. 4 is an example of an XML based document;

FIG. 5 is a table showing an example of discovery information retrieved from a network; and

FIG. 6 is a table showing an example of manipulated discovery information.

### DETAILED DESCRIPTION

The present invention includes unique ways to discover systems or devices on a network. Extensible Markup Language (XML) based data is used to share the discovery information over Internet transport. It allows for an efficient use of Internet content search engines in processing the data. Network topology maps may be created based on the information discovered.

Discovery information, such as identification, location, or capability data, is stored on the devices of a network in the form of XML documents. The discovery information about the networked systems or devices is exchanged using XML/HTTP protocols. Powerful XML based search engines are used for Internet content filtering and retrieval. A combination of these two technologies renders a tool for dynamically building network maps based on the discovery information that is queried and retrieved from the various XML documents on the networked devices. The network nodes can then be further classified based on the node types and other parameters. Specific network maps for a specific management domain can then be rendered.

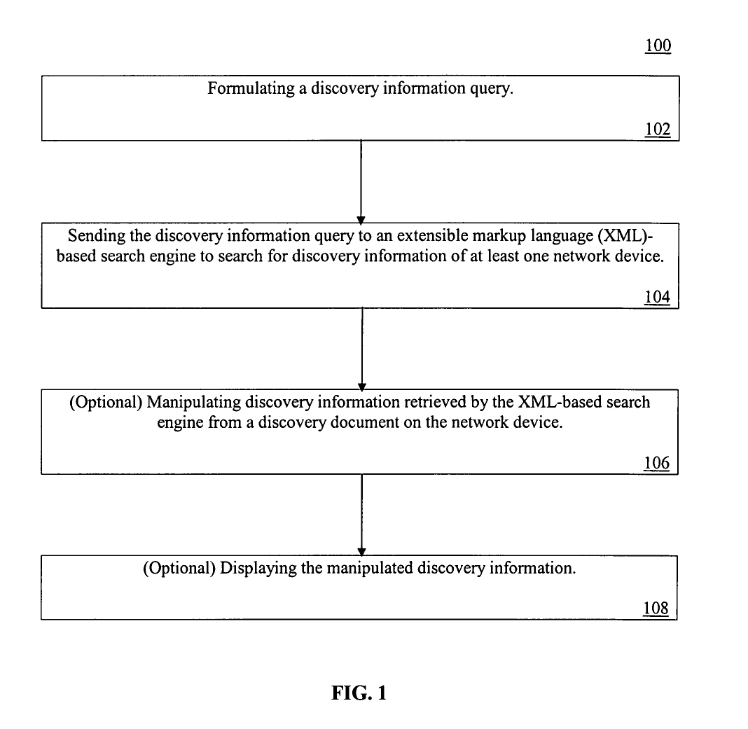

The particular methods of the invention can described with reference to the flowchart shown in FIG. 1 in which one embodiment of the method 100 constitutes processes and operations represented by block 102 until 108. Embodiments of the method may constitute computer programs made up of computer-executable instructions illustrated as blocks 102 until 108 in FIG. 1.

Describing the methods by reference to a flowchart enables one skilled in the art to develop such programs including such instructions to carry out the methods on suitably configured computers (the processor of the computer executing the instructions from computer-readable media). If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or a produce a result.

Embodiments of the invention can include software stored or transmitted on or by a machine-readable medium. Thus, a machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

FIG. 1 shows a flowchart of an exemplary method 100 of the present invention in which the various blocks represent operations or procedures to perform the method 100. Block 102 shows the operation of formulating a discovery information query. Block 104 shows the operation of sending the discovery information query to an XML based search engine to search for discovery information of at least one network device.

Formulating the discovery information query can be performed at a console or at one of the devices on the network. For example, a user can formulate and input a query at an end user station such as a personal computer that is connected to the network. The XML based search engine then searches the network for discovery information that is on the device or devices that are being searched. The discovery information is in XML format that is preferably standardized. The XML discovery information is described in further detail below.

Additional operations that can be performed in the method 100 are represented by blocks 106 and 108. Block 106 shows the optional operation of manipulating discovery information retrieved by the XML-based search engine from a discovery document on the network device. As discussed in further detail below, the retrieved XML information can be transposed or manipulated to yield a network map, topology, or tree that can be displayed for the user. Block 108 shows the optional operation of displaying the manipulated discovery information.

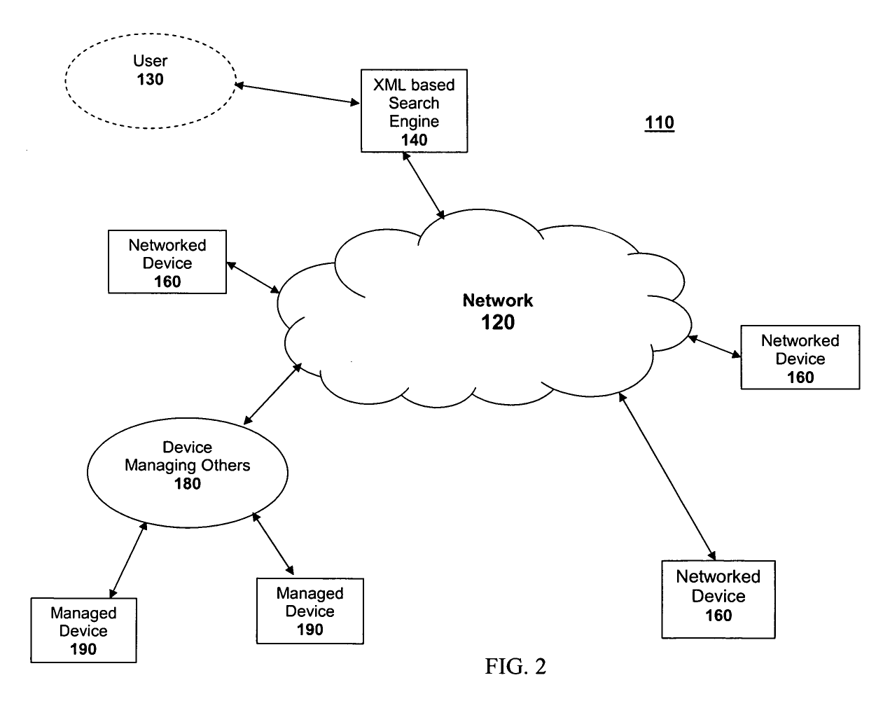

FIG. 2 shows an exemplary embodiment of a system 110 of the present invention. System 110 includes a network 120. Network 120 can be any type of network that has a plurality of devices or systems associated with it. Exemplary embodiments of network 120 can include a local area network (LAN) or a wide area network (WAN). For purposes of description of the present invention, it should be noted that the Internet can be considered a collection of networks or a large network by itself.

In the exemplary system 110 shown in FIG. 2, a user 130 formulates a query to send to the network 120 through an XML based search engine 140. The XML based search engine can include a query formulation device in which the user 130 inputs the parameters that are to be searched. The network 120 can be searched for a particular type of device 160 to discover information about the device such as how many of that type of device are connected or operating, the status of all such devices, or the capabilities of particular devices such as whether a particular printer is post-script enabled or has color capability, for example. In another example, the IP addresses can be discovered which can provide information about the location or type of device. Examples of devices 160 or systems that can be discovered include switches, routers, servers, printers, computer, etc.

The system 110 can include devices that manage other devices such as device 180. As shown in FIG. 2, device 180 manages managed devices 190. Managing device 180 can be referred to as a proxy system.

Each device 160, 180, and 190 can include its own XML discovery information. Alternatively, the proxy system or managing device 180 can include XML discovery information about its managed devices 190.

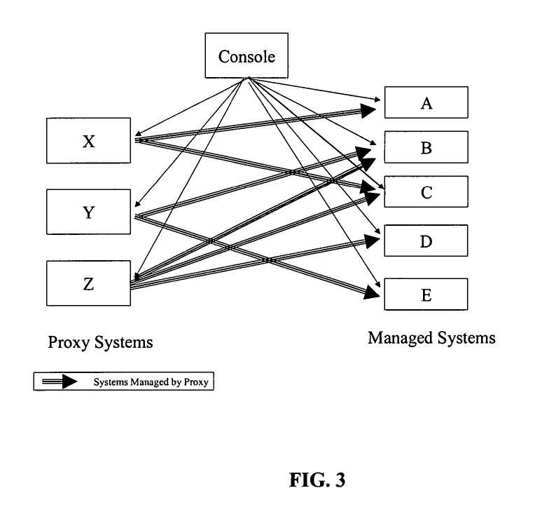

FIG. 3 shows another example of a network on which the discovery method of a present invention can be used. The systems A, B, C, D & E are systems on the network that can be managed by the Console system. These systems can either be directly discovered and managed by the console, or they can be managed via a third system (Proxy System). In FIG. 3, Systems X, Y and Z are proxy systems. The broad arrows indicate the systems managed by each proxy system.

It should be noted that the systems in FIG. 3 are identified as “Proxy” and “Managed” systems for illustration purposes only. In the real world, the systems A, B, or C could also act as Proxy for D and E, for example. Systems X and Y could also be the managed systems.

System Discovery Information

Implementation of the present invention preferably includes devices on the network that have their individual discovery/identification data in a standard format. This format is preferably based on Extensible Markup Language (XML). Using XML definitions, a well-structured information content document is published by the devices or systems. Furthermore, defining an XML format allows this information to be routed through HTTP and through firewalls, thus making this information available anywhere and anytime.

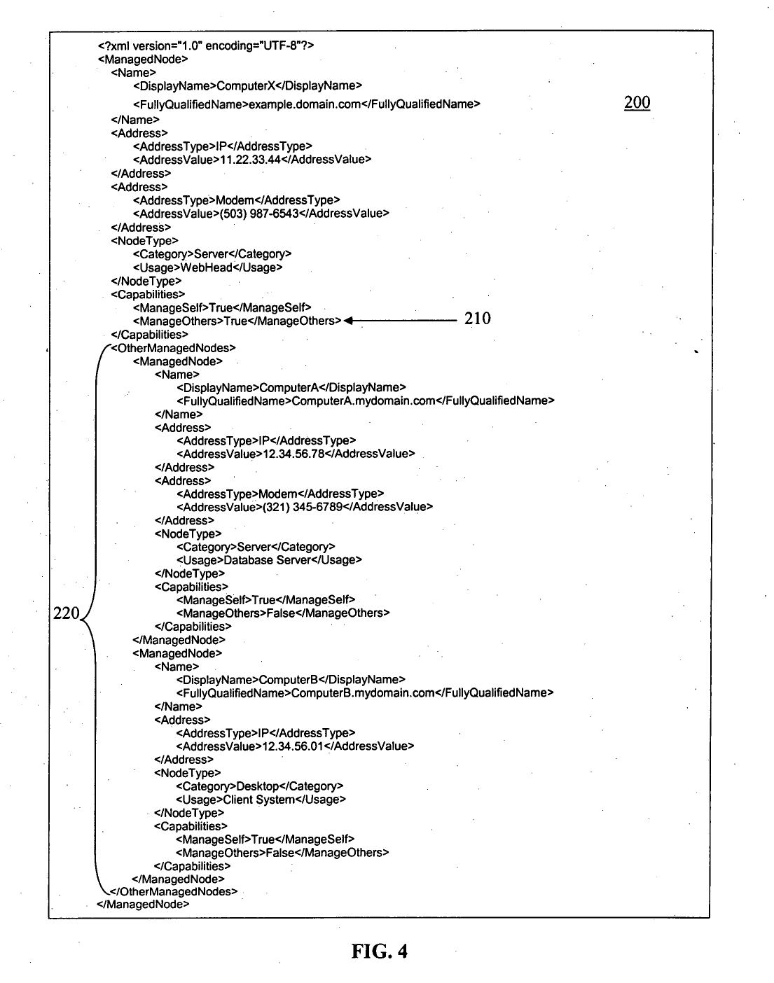

FIG. 4 shows an example of an XML file 200 that can be provided on networked devices. XML file 200 can be referred to as a discovery document containing discovery information. The discovery information in XML file 200 can provide many categories of information. For example, line 210 which reads “<ManageOthers>True</ManageOthers>” indicates that the device associated with XML file 200 is a “proxy” system such as a server that manages other devices or systems.

Another example of the discovery information that may by contained in an XML file is represented by the set of lines 220. The set of lines indicated by reference numeral 220 includes discovery information about the devices that are managed by the proxy device. An example of a proxy device or system is a server. Locating the XML file 200 on a proxy device allows the various network devices such as printers, routers, switches, etc. to not have their own XML files. The server, for example, can retrieve the information about the various devices that it manages through current protocols when an XML based network discovery search is performed. The search engine, in this case, need only query the server. If desired, the search engine can be directed to query only particular portions of the XML file. For example, a search can be made that is directed only to the “other managed nodes” section of the XML file 200.

The discovery information is in XML format because XML search engines are used to conduct the network discovery. Many devices currently in use, however, do not include an XML file that includes such information. Modification or replacement of current network devices is not necessary, however, because proxy system can be used to store the information about the various devices.

Making Discovery Information Available

The discovery information encoded in the XML file on the device can be supplied to any consumer of the data. Any protocol for transfer can be used. The Internet standard HyperText Transfer Protocol (HTTP) is very well suited for transferring XML content from one system to another, and is the preferred protocol. The system providing this data can publish a URL containing the XML data. As long as the URL is available somewhere, the specific location of the URL is not important.

For example, the URL containing the XML data for a particular device can be located on a server. An example of such a URL could be http://www.serverl.myorg/ManagedCapabilities. In another example, the XML can be embedded on a router and can have the exemplary URL http://192.9.200.34/. In yet another example, a management system which collects data from multiple devices can include the exemplary URL http://www.ManagementServer.myorg/ManagedDevices. In yet another example, a device on “my” local network could include the exemplary URL http://mydevice:80/data.

XML Search Engines

The present invention utilizes power of available Internet search engines. These search engines provide a good way to search for the content on the Internet. Typically, these search engines search for text in the HTML or other text documents, and report results that are the closest match. Some of the search engines provide enhanced capabilities to match keywords (specified in the documents) and thus provide better search results. Building upon this, an XML based search engine searches data under specific XML tags, and thus provides very accurate results.

To illustrate this, a search for ManagedNode/NodeType/Category=“Server” will only return the XML documents that contain Server systems. The search engine will limit the search to the above XML tag (as specified by a specific document type definition or “DTD”). Thus, it will not retrieve thousands of documents containing the word “Server.”

Manipulating the Discovery Information

The discovery information can contain not only the particular system or device identification data, but also the information about other systems or devices that can be managed through the particular system or device on which the discovery information is stored.

Once the Console system performs an XML search using the search engine, it essentially has the XML documents from all the systems on the managed network. These XML documents are from all the managed systems as well as from the Proxy systems. Of course, the Console system could limit the search to a specific tag, and only retrieve documents of relevance.

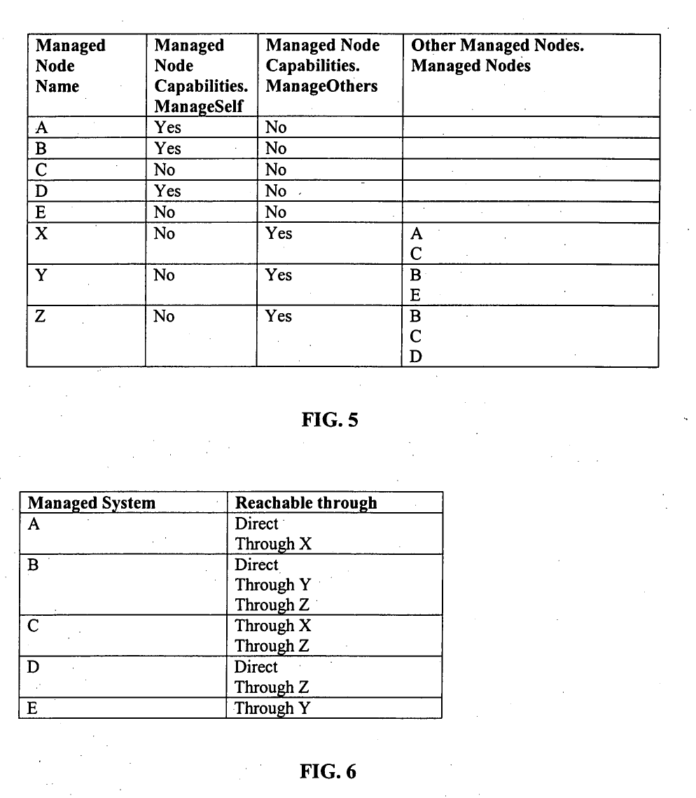

FIG. 5 shows an example of a table of information that can be retrieved by the Console system in the process of creating a network map of the network shown in FIG. 3. The next task for the console is to transpose the table of FIG. 5 with the focus on the managed system, and how it can be reached via different alternate paths. This will yield the table shown in FIG. 6.

Based on the table of FIG. 6, the network map in the Console will be updated to reflect that a system is manageable and contains the information necessary to manage the system. For example, referring to FIG. 6, the system B on the network map reflects the status of the system, and the fact that it can be managed directly from the Console. This will be true even if the operating system on system B is crashed/hung. The system is still available through Y or Z. If Y goes down, the system is still available through Z. If Z is also down, then the management launch point is disabled.

These components together create a powerful mechanism to allow network and systems management tools to create a generic network topology map or table, describe the systems on the network, and provide ways to manage these systems effectively.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A system comprising:
a server coupled with a client, the server having a console having a managing device to manage one or more network devices; and
a search engine coupled with the managing device via a network including the Internet, the search engine capable of being accessed via the client, wherein the console to
formulate an Extensible Markup Language (XML) discovery information query, wherein the XML discovery information query is initiated automatically by the client,
send the XML discovery information query to the search engine to facilitate searching of discovery information relevant to the one or more network devices, wherein at least one of the one or more network devices includes an XML discovery information file, wherein at least one of the one or more network devices does not include the XML discovery information file,
in response to sending the XML discovery information query, receive one or more of the following via the search engine:
first discovery information from the one or more network devices having the XML discovery information file, and
second discovery information from a proxy device for the one or more network devices not including the XML discovery information files, and
generate a network topology map for the one or more network devices via the retrieved first and second discovery information.

2. The system of claim 1, wherein the console is further to manipulate the retrieved first and second discovery information.

3. The system of claim 2, further comprising a display device coupled with the server and the client, the display device to display the manipulated discovery information.

4. The system of claim 1, wherein the search engine comprises an Internet-based search engine.

5. A system comprising:
one or more network devices, each network device having stored thereon one or more files containing discovery information; and
a search engine coupled with the one or more network device via a network including the Internet, the search engine to search the discovery information of the one or more files stored on the one or more network devices via a discovery information query, wherein the search engine includes
a query formulation device to
input one or more of the following parameters: type of the one or more network devices, status of the one or more network devices, and capabilities of the one or more network devices, wherein the discovery information query is formulated at a console or at the one or more network devices, the console including a managing device to manage the one or more network devices, wherein the discover information query is initiated automatically via a client, and the discovery information query is sent to the search engine to facilitate the searching of the discovery information relevant to the one or more network devices, wherein the discovery information includes Internet Protocol (IP) addresses corresponding with the one or more network devices, and
generate a network topology map for the one or more network devices via the discovery information.

6. The system of claim 5, wherein the search engine comprises an Internet-based search engine including an Extensible Markup Language (XML)-based search engine, and the one or more files including one or more XML-based files.

7. The system of claim 5, wherein the one or more network devices comprise one or more of a router, a switch, a server, a printer, and a computer.

8. The system of claim 5, wherein the discovery information comprises one or more of data describing capabilities of the one or more network devices, data describing locations of the one or more network devices, and data describing types of the one or more network devices.

9. A method comprising:
inputting one or more of type of one or more network devices, status of the one or more network devices, and capabilities of the one or more network devices via a query formulation device of a search engine, wherein the search engine coupled with the one or more network devices via a network including the Internet, the search engine to search discovery information of one or more files stored on the one or more network devices via a discovery information query, wherein the discovery information query is formulated at a console or at the one or more network devices, the console including a managing device to manage the one or more network devices, wherein the discover information query is initiated automatically via a client, and the discovery information query is sent to the search engine to facilitate the searching of the discovery information relevant to the one or more network devices, wherein the discovery information includes Internet Protocol (IP) addresses corresponding with the one or more network devices; and
generating a network topology map for the one or more network devices via the discovery information.

10. The method of claim 9, wherein the search engine comprises an Internet-based search engine including an Extensible Markup Language (XML)-based search engine, and the one or more files including one or more XML-based files.

11. The method of claim 9, wherein the one or more network devices comprise one or more of a router, a switch, a server, a printer, and a computer.

12. The method of claim 9, wherein the discovery information comprises one or more of data describing capabilities of the one or more network devices, data describing locations of the one or more network devices, and data describing types of the one or more network devices.

13. A machine-readable medium comprising instructions which, when executed, cause a machine to:
input one or more of type of one or more network devices, status of the one or more network devices, and capabilities of the one or more network devices via a query formulation device of a search engine, wherein the search engine coupled with the one or more network devices via a network including the Internet, the search engine to search discovery information of one or more files stored on the one or more network devices via a discovery information query, wherein the discovery information query is formulated at a console or at the one or more network devices, the console including a managing device to manage the one or more network devices, wherein the discover information query is initiated automatically via a client, and the discovery information query is sent to the search engine to facilitate the searching of the discovery information relevant to the one or more network devices, wherein the discovery information includes Internet Protocol (IP) addresses corresponding with the one or more network devices; and
generate a network topology map for the one or more network devices via the discovery information.

14. The machine-readable medium of claim 13, wherein the search engine comprises an Internet-based search engine including an Extensible Markup Language (XML)-based search engine, and the one or more files including one or more XML-based files.

15. The machine-readable medium of claim 13, wherein the one or more network devices comprise one or more of a router, a switch, a server, a printer, and a computer.

16. The machine-readable medium of claim 13, wherein the discovery information comprises one or more of data describing capabilities of the one or more network devices, data describing locations of the one or more network devices, and data describing types of the one or more network devices.
